(19) United States
(12) Patent Application Publication
(10) Pub. No.: US 2004/0113325 A1
(43) Pub. Date: Jun. 17, 2004

(54) Method of fabricating PTFE material

(76) Inventor: Warran B. Lineton, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/643,097

(22) Filed: Aug. 18, 2003

Related U.S. Application Data
(63) Continuation-in-part of application No. 10/223,206, filed on Aug. 19, 2002, now Pat. No. 6,676,880.

(51) Int. Cl. B29C 67/04

(52) U.S. Cl. 264/489; 264/127

(57) ABSTRACT

A method of manufacturing PTFE material includes preparing a mixture of PTFE resin powder and a susceptor material which is compacted and sintered by exciting the susceptor material with microwave energy. Preferably, the compaction and sintering of the mixture is carried out in a continuous process and a vacuum is drawn on the mixture in the heating zone to extract any air from the mixture. The sintered mixture may be advanced, preferably continuously, to a cutting zone where the PTFE material may be cut to any desired length preferably while the mixture is still warm to produce anywhere from thin wafer PTFE components to long tubular PTFE hose, or the like.

This application is a continuation in part of U.S. Ser. No. 10/223,206 filed Aug. 19, 2003.

### BACKGROUND OF THE INVENTION

1. Field of the Invention

The invention relates generally to the manufacture of polytetraflouroethylene (PTFE) material for application such as PTFE seals.

2. Related Art

The art of producing effective seals between a rotating member and a stationary member is under continual development. It is well know that seals acting between a rotating member and a stationary member often comprise a PTFE component in combination with an elastomer component. The manufacture of the PTFE seal component is typically the bottleneck in the process of producing a seal. PTFE is difficult to form to a desired shape due to its inherent heat resistant characteristics, and thus, poor conductivity. This makes PTFE difficult to mold, thus complicating the manufacture process of making components parts from PTFE.

Typically, PTFE is formed to the desired component geometry by exposing PTFE resin powder to melting temperatures, in the desired mold geometry, for an extended period of time. The amount of time required to process the PTFE resin powder from a “green” state to a cured or sintered state can take anywhere between 2 to 10 hours or more, depending on the geometry sought. This amount of time investment to produce a component for a seal is highly cost inefficient from the standpoint of labor, energy consumption, and space consumption in a furnace, among other associated costs. Additionally, the interruption of the manufacture process to produce a seal by having to spend so much time in a single operation, i.e. sintering of the PTFE seal element, prevents manufacturing efficiencies otherwise possible by utilizing a continuous manufacturing process.

Therefore, being as many seals in production today utilize a PTFE component for its lubricious properties, it would be highly advantageous to have a process for construction a PTFE seal component in an efficient manner. A method of constructing a PTFE seal component according to the current invention as described hereafter in a currently preferred embodiment of the invention overcomes or greatly minimizes the limitations of prior methods of forming a seal component manufactured from PTFE.

### SUMMARY OF THE INVENTION

A method of fabricating PTFE material is provided in a quick and relatively cost efficient manner. The method involves preparing a mixture of PTFE resin powder and a susceptor material. The mixture is then routed to a compacting zone wherein the mixture is compacted to a shape. Following compaction, the mixture is sintered by exciting the susceptor material via microwave energy to generate heat uniformly throughout the mixture.

One advantage of the present invention is that PTFE material can be fabricated in a relatively short period of time.

Another advantage of the invention is that the costs associated with the production of PTFE is reduced.

Another advantage of the invention is that a PTFE component can be constructed in a continuous process.

Another advantage of the invention is that a PTFE component can be constructed relatively uniform in strength.

Another advantage of the invention is that PTFE resin powder may be compacted to a more uniform density, thus producing a more uniform PTFE component.

### BRIEF DESCRIPTION OF THE DRAWINGS

These and other features, advantages, and benefits of the invention will become more readily appreciated when considered in connection with the following detailed description and appended drawings, wherein:

FIG. 1 is a flow diagram of a method for constructing a PTFE component.

FIG. 2 is a schematic illustration of the method of FIG. 1; and

FIG. 3 shows a plan view of a PTFE seal component made from the PTFE seal material prepared according to the invention.

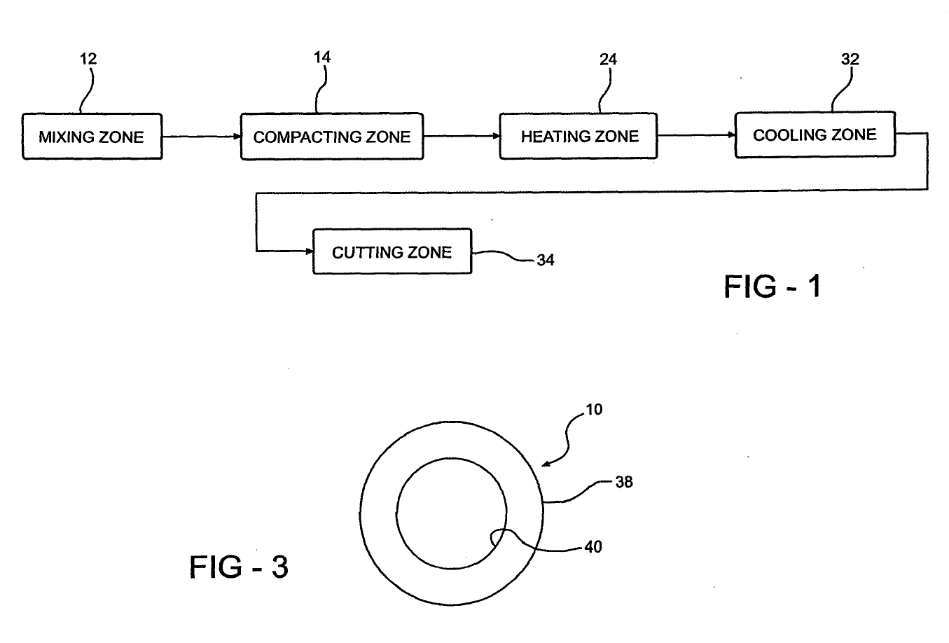

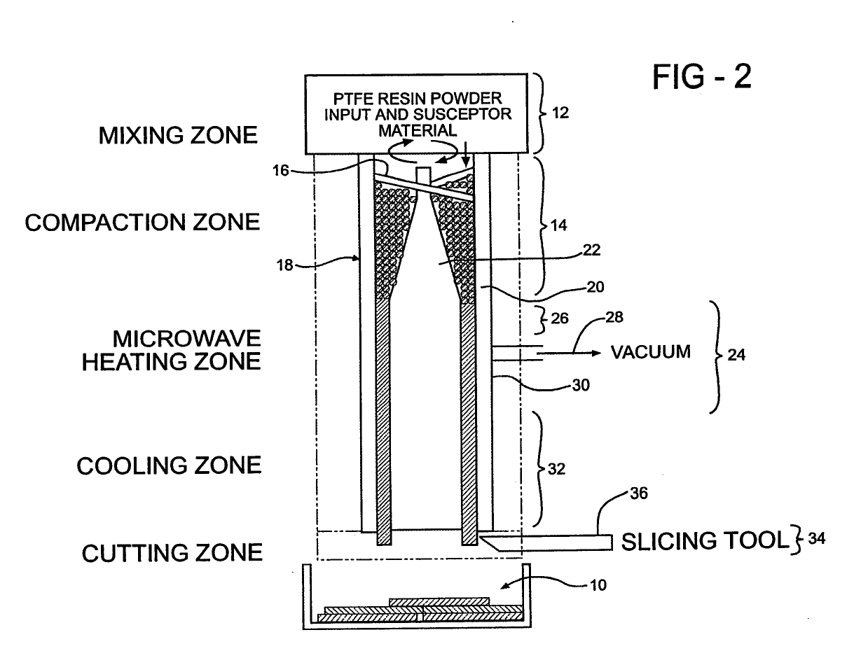

### DETAILED DESCRIPTION

PTFE material is made according to the invention by preparing a mixture of a PTFE resin powder with a susceptor material, preferably one that has lubricious characteristics such as graphite or the like and which is reactive to exposure to microwave energy. The mixture of PTFE resin powder and susceptor material takes place in a mixing zone 12 to preferably create a homogeneous mixture of the materials. It should be recognized that any mixing apparatus may be used to create the homogeneous mixture.

Following the mixing zone 12 is a compaction zone 14 for at least partially compacting the mixture. Initial stages of the compaction may occur in the mixing zone 12, but preferably the majority of the compaction occurs in the compaction zone 14. When the mixture is in the compaction zone 14, the mixture is in a “green” state. A blade member 16 rotates to compress the mixture of PTFE resin powder and susceptor material within a mold or tool 18 to take on a desired shape to create a generally “green” billet of PTFE resin powder and susceptor material. Here, the desired geometry is generally tubular or cylindrical in shape, and is established by compacting the mixture between an outer cylindrical wall 20 and an inner mandrel 22 of the tool 18. It should be recognized that the shape need not be confined to a tubular geometry, and that any desired shape may be formed.

Upon compacting the mixture of the PTFE resin powder and susceptor material, the mixture is transferred to a heating zone 24, preferably in a continuous flow from the compaction zone 14 to reduce the amount of handling required throughout the manufacturing process. The heating zone 24 is shown here as a microwave-heating zone wherein microwaves excite the susceptor material to generate the heat required to sinter the mixture. Sintering the mixture causes the PTFE resin powder and susceptor material to cross-link, thus creating a resilient and dense polymerized billet of PTFE and susceptor material. It should be recognized that though microwaves are depicted here as the energizing source other equivalent RF frequencies, or a magnetic field may be used and are contemplated to excite the susceptor material, and that the energizing source need not be limited to microwaves.

As the mixture enters the heating zone 24, preferably a preheating stage 26 is provided to preheat the mixture, while at the same time further compacting the mixture, to creating a more dense mixture. To further facilitate a more uniform and dense mixture, a vacuum 28 is preferably drawn on the mixture within the heating zone 24 to extract air from the mixture. The vacuum 28 is generated by any suitable connection of a vacuum line (not shown) through an outer perimeter 30 of the heating zone 24. The additional compaction and vacuum in the heating zone 24 promotes a more uniform sintered billet of PTFE and susceptor material by removing any porosity that may have resulted otherwise. This helps to create a more resilient PTFE seal component, and thus extends the useful life of the PTFE seal component 10 in use.

Upon being preheated, the mixture flows continuously within the heating zone 24 where the susceptor material is further excited by microwaves, thus generating more heat to facilitate heating and sintering of the mixture. The addition of the susceptor material makes an otherwise unmicrowavable PTFE resin powder microwavable. By microwaving the susceptor material within the PTFE resin powder, the sintering time required for the PTFE resin powder is substantially reduced, thus greatly increasing the production rates, while lowering the cost of producing the PTFE seal component 10. Not only is the time required to produce the PTFE seal component greatly reduced, but also the resources required to produce the seal component 10, such as labor, energy, space, and the like.

Upon being sintered in the heating zone 24, the mixture is preferably advanced continuously to a cooling zone 32. Cooling of the sintered billet culminates the curing process, and solidifies the cross-linking of the PTFE and susceptor material polymer. The billet, though substantially cooled in the cooling zone 32, preferably may remain at least partially heated as it exits the cooling zone to accommodate further processing, if desired.

Upon exiting the cooling zone 32, the billet may be advanced continuously to a cutting zone 34. The cutting zone 34 is comprised of any suitable cutting device, such as a blade member 36 for cutting the PTFE material to a desired length, ranging from thin wafer form to longer tubular or solid form (such as for PTFE hose applications). Preferably, the mixture or billet remains at a partially heated temperature wherein the temperature is lower than the sintering temperature within the heating zone 24, but higher than the ambient temperature so that the cutting process for cutting the desired thickness of the PTFE component 10 is improved. The example shown in the figures illustrates the cutting of thin wafers for seal applications, but it will be appreciated that the length could be increased to produce, for example, PTFE hose. Cutting an at least partially heated billet improves the quality and function of the PTFE component 10 by reducing or eliminating plastic deformation that otherwise may result in the cutting process. Therefore, cutting of the desired thickness of the PTFE component 10 from the advancing mixture is made easier by imparting a more precise shear of the billet material as the blade member traverses through the billet to cut the finished PTFE component.

The resulting PTFE component 10 may be generally annular in shapes as illustrated in FIG. 3 and may have an outer perimeter 38 and an inner perimeter 40 for receiving a shaft (not shown).

Obviously, many modifications and variations of the present invention are possible in light of the above teachings it is, therefore, to be understood that within the scope of the appended claims, the invention may be practiced otherwise than as specifically described. The invention is defined by the claims.

What is claimed is:

1. A method of fabricating PTFE material comprising:
preparing a mixture of PTFE resin powder and a susceptor material;
feeding the mixture into a compaction zone to at least partially compact and shape the mixture; and
providing a continuous flow of the mixture from the compaction zone to a heating zone and heating and sintering the mixture within the heating zone by exciting the susceptor material by application of wave energy.

2. The method of claim 1 including drawing a vacuum on the mixture within the heating zone to extract air from the mixture.

3. The method of claim 2 wherein the heating zone has an initial stage for preheating and finishing compaction of the mixture prior to sintering the mixture.

4. The method of claim 2 including passing the sintered mixture through a cooling zone following the heating zone.

5. The method of claim 1 including cutting the PTFE material while the mixture is at a temperature below a sintering temperature within the heating zone but above ambient temperature.

6. The method of claim 1 wherein the mixture is compacted into a generally tubular form.

7. The method of claim 1 wherein the mixture is heated by microwave energy.

8. A method of fabricating a PTFE material, comprising:
preparing a mixture of PTFE resin powder and a susceptor material;
compacting the mixture; and
sintering the mixture by exciting the susceptor material with microwave energy.

9. The method of claim 8 including drawing a vacuum on the mixture during the sintering step to extract air from the mixture.
